(19) United States
(12) Patent Application Publication
(10) Pub. No.: US 2024/0059930 A1
(43) Pub. Date: Feb. 22, 2024

(54) LAMINATE AND METHOD FOR DETACHING THE SAME

(71) Applicant: tesa SE, Norderstedt (DE)

(72) Inventors: Shuang Wang, Hamburg (DE); Klaus Keite-Telgenbüscher, Hamburg (DE); Thorsten Krawinkel, Hamburg (DE)

(73) Assignee: tesa SE, Norderstedt (DE)

(21) Appl. No.: 18/452,078

(22) Filed: Aug. 18, 2023

(30) Foreign Application Priority Data
Aug. 19, 2022 (DE) 102022121016.2

(51) Int. Cl. C09J 5/06; C09J 7/38; C08J 9/22; B32B 15/20; B32B 27/36; B32B 7/12; B32B 15/09; B32B 27/08; B32B 43/00; B32B 7/06

(52) U.S. Cl. CPC C09J 5/06; C09J 7/381; C08J 9/22; B32B 15/20; B32B 27/365; B32B 7/12; B32B 15/09; B32B 27/08; B32B 43/006; B32B 7/06; C09J 2301/502; C08J 2203/22; C08J 2375/04; C08J 2207/02; C09J 2425/00; B32B 2255/06; B32B 2255/26; B32B 2255/28; B32B 2307/748; B32B 2405/00

(57) ABSTRACT

A laminate that includes:
(i) a first pressure-sensitive adhesive layer, the first layer comprising a block copolymer containing at least one polymer block formed from vinylaromatics and at least one polymer block formed from alkenes;
(ii) a metal layer disposed on the first layer;
(iii) a blowing agent layer disposed on the metal layer; and
(iv) a second pressure-sensitive adhesive layer disposed on the blowing agent layer, the second layer comprising a block copolymer containing at least one polymer block formed from vinylaromatics and at least one polymer block formed from alkenes.

### CROSS-REFERENCE TO RELATED APPLICATIONS

This application claims the benefit of priority under 35 U.S.C. § 119(b) of German Patent Application No. 102022121016.2, entitled LAMINATE, and filed Aug. 19, 2022, the contents of which is relied upon and incorporated herein by reference in its entirety.

### FIELD OF THE DISCLOSURE

The present invention relates to a laminate. The present invention further relates to a method for producing this laminate. The present invention further relates to an arrangement comprising the laminate and to a method for detaching the laminate.

### BACKGROUND

The majority of adhesive tape solutions are not detachable or not without damage to the substrates. Recently there has been an increased interest in “debonding-on-demand” functionalities, having come about owing to environmental laws and/or the awareness on the part of the end customers of sustainability, and an increasing cost pressure affecting production. The application scenarios for debonding processes are classified in reworking, repairing, recycling and processing aids. At the focus of the present invention is the reliable parting or separating of two substrates bonded using a laminate. Certain detachment approaches are described by C. Sato in “Recycling and environmental aspects”, 2011, 58, 20, pages 1506-1526 and by A. Hutchinson et al. in Journal of Adhesion, 2016, “Overview of disbonding technologies for adhesive bonded joints”, pages 737-755. A systematic approach to the ordering of debonding technologies is likewise provided by the materials testing committee of the DIN standards committees (NA 062-10-02 AA Test methods in constructive adhesive bonding).

The debonding technologies are aimed at achieving cohesive splitting of the layer of adhesive or adhesive detachment of the layer of adhesive from the substrate. While the former requires cleaning of the substrate prior to rebonding, the latter manages without it. Adhesive dissolution technologies which guarantee the requisite high and durably reliable bond strength, however, are generally more difficult to realize or take a very long time to apply, such as detachment by means of an undermining solvent, for example. At the present time, accordingly, especially in the reworking or repair of electronic devices, such as smartphones and tablet computers, for example, the adhesive bonds used are primarily cohesively splitting bonds, in many cases implemented in the form of pressure-sensitive adhesive tapes, which through an increase in temperature have their cohesion diminished to an extent such that the bond can be parted manually, cohesively. Extensive reworking to prepare the substrate surface, contaminated with remnants of adhesive, for rebonding are the consequence.

EP2493995B1 describes a method for bonding a heat-activatedly bondable sheetlike element with a bonding substrate that has a coefficient of thermal conduction of at most 5 W/mK. In the method, sheetlike elements are contacted with the adhesive layer and then inductively bonded under pressure in an alternating electromagnetic field, inductively at a frequency of 100 Hz to 200 kHz for a time of at most 20 s, under a pressing pressure of at least 1 MPa.

EP1814703B1 describes a process for recycling electrical or electronic components, where an adhesive bond produced by means of a pressure-sensitive adhesive between two constituent parts of the component is separated, through supply of energy to expandable particles located in the pressure-sensitive adhesive, which expand and, in so doing, explode the bonded assembly.

EP2516573B1 describes a method for bonding and separation of two substrate surfaces, where the bonding takes place using a heat-activatedly bondable sheetlike element having two layers of different heat-activatable adhesives. The bonding takes place at a temperature T1, at which simultaneous heat activation of the two heat-activatable adhesives takes place. The separation takes place at a temperature T2, at which, under mandated conditions, only one of the heat-activatable layers of the heat-activatedly bondable sheetlike element loses its bonding effect in the bonded assembly to an extent such that the bonded assembly is parted.

The known mechanisms for detachment are generally realized in the layer of adhesive itself and/or in the interface of the adhesive with the substrate.

It is therefore desirable to provide a laminate, a method and an arrangement which avoid or very largely avoid the described disadvantages of aforesaid laminates, methods and arrangements. The intention in particular is to provide a laminate for which the adhesive bond between two substrates and/or a corresponding adhesive tape or an apparatus composed of adhesive tapes can be reliably undone. The preservation of a high and durably reliable bond strength is to be combined in this case with a rapid separability. Moreover, the adherends can be very easily cleaned again, allowing them to be reused without cost or complexity.

### SUMMARY OF THE DISCLOSURE

This object is addressed by a laminate comprising a first pressure-sensitive adhesive layer, comprising a block copolymer containing at least one polymer block formed from vinylaromatics and at least one polymer block formed from alkenes, a metal layer which is heatable by magnetic induction, a blowing agent layer, and a second pressure-sensitive adhesive layer, comprising a block copolymer containing at least one polymer block formed from vinylaromatics and at least one polymer block formed from alkenes. In this laminate, at least one pressure-sensitive layer can be removed by extensive stretching.

The present invention therefore relates to a laminate comprising layers as follows:
(i) a first pressure-sensitive adhesive layer, comprising a block copolymer containing at least one polymer block formed from vinylaromatics and at least one polymer block formed from alkenes;
(ii) a metal layer;
(iii) a blowing agent layer; and
(iv) a second pressure-sensitive adhesive layer, comprising a block copolymer containing at least one polymer block formed from vinylaromatics and at least one polymer block formed from alkenes.

According to an aspect of the disclosure, a laminate is provided that includes:
(i) a first pressure-sensitive adhesive layer, the first layer comprising a block copolymer containing at least one polymer block formed from vinylaromatics and at least one polymer block formed from alkenes;
(ii) a metal layer disposed on the first layer;
(iii) a blowing agent layer disposed on the metal layer; and
(iv) a second pressure-sensitive adhesive layer disposed on the blowing agent layer, the second layer comprising a block copolymer containing at least one polymer block formed from vinylaromatics and at least one polymer block formed from alkenes.

According to another aspect of the disclosure, an arrangement is provided that includes: a laminate; a first substrate; and a second substrate, wherein the laminate is disposed between the first and second substrates. Further, the laminate includes:
(i) a first pressure-sensitive adhesive layer, the first layer comprising a block copolymer containing at least one polymer block formed from vinylaromatics and at least one polymer block formed from alkenes;
(ii) a metal layer disposed on the first layer;
(iii) a blowing agent layer disposed on the metal layer; and
(iv) a second pressure-sensitive adhesive layer disposed on the blowing agent layer, the second layer comprising a block copolymer containing at least one polymer block formed from vinylaromatics and at least one polymer block formed from alkenes.

According to a further aspect of the disclosure, a method for detaching a laminate is provided that includes: providing an arrangement, the arrangement comprising: a laminate; a first substrate; and a second substrate, wherein the laminate is disposed between the first and second substrates; exposing the arrangement according to a temperature in a range from 40 to 200° C.; and separating the laminate, wherein the laminate comprises:
(i) a first pressure-sensitive adhesive layer, the first layer comprising a block copolymer containing at least one polymer block formed from vinylaromatics and at least one polymer block formed from alkenes;
(ii) a metal layer disposed on the first layer;
(iii) a blowing agent layer disposed on the metal layer; and
(iv) a second pressure-sensitive adhesive layer disposed on the blowing agent layer, the second layer comprising a block copolymer containing at least one polymer block formed from vinylaromatics and at least one polymer block formed from alkenes.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF DRAWINGS

Further details and features of the present invention are apparent from the description of figures and working examples. Here, the respective features may be realized on their own or as two or more in combination with one another. The invention is not confined to the working examples. The working examples are represented schematically in the figures. Identical reference numerals in the individual figures here denote identical or functionally identical elements or elements which correspond to one another in terms of their functions.

FIG. 1 is a cross-sectional view of a laminate, according to one or more embodiments of the disclosure;

FIG. 2 is a cross-sectional view of an arrangement that includes a laminate, according to one or more embodiments of the disclosure; and

FIGS. 3A-3C are cross-sectional views of an arrangement depicted in FIG. 2, as subjected to a method for detaching a laminate, according to one or more embodiments of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, a “laminate” is a term for a material or a product which consists of two or more layers bonded to one another in sheetlike form. These layers may consist of identical or different materials. A laminate may be produced by lamination or by direct coating.

The first pressure-sensitive adhesive layer (i) and/or the second pressure-sensitive adhesive layer (iv) preferably comprises an elastomer component (a), a tackifier resin component (b) and optionally a plasticizing resin component (c). The first pressure-sensitive adhesive layer (i) and/or the second pressure-sensitive adhesive layer (iv) more preferably comprises an elastomer component (a), a tackifier resin component (b) and a plasticizing resin component (c).

The elastomer component (a) preferably comprises a block copolymer having an A-B-A, (A-B)ₙ, (A-B)ₙX or (A-B-A)ₙX construction, preferably a diblock copolymer A-B and/or a triblock copolymer A-B-A, in which
the blocks A independently of one another comprise a polymer preparable from a polymerization mixture containing vinylaromatic monomers having 8 to 12 carbon atoms;
the blocks B independently of one another comprise a polymer preparable from a polymerization mixture containing alkene monomers having 4 to 18 carbon atoms;
X comprises a radical of a coupling reagent or initiator; and
n≥2.

The coupling reagent is used to connect two or more vinylaromatic-diene diblocks to one another. The initiator is used for preparing the elastomer component (a), and could, for example, be sodium naphthalide, which enables chain growth in two directions.

The blocks A are preferably preparable from a polymerization mixture containing styrene and α-methylstyrene, preferably preparable from a polymerization mixture containing styrene. The blocks B are preferably preparable from a polymerization mixture containing monomers of 1,3-dienes and isobutylene, more preferably preparable from a polymerization mixture containing butadiene and/or isoprene. To provide polydienes with a pressure-sensitive adhesive character, they must be admixed with tackifier resins. The same is true of vinylaromatic block copolymers which contain polydiene blocks.

The blocks A preferably have a fraction in the block copolymer in a range from 14 to 35 wt %, more preferably in a range from 14 to 30 wt %. The blocks B preferably have a fraction in the block copolymer in a range from 65 to 86 wt %.

As well as the at least one vinylaromatic block copolymer, the pressure-sensitive adhesive layer has at least one tackifier resin component (b) in order to increase the adhesion in a desired manner. The tackifier resin component (b) ought to be compatible with the elastomer component (a) of the block copolymers and more particularly with the blocks B of the block copolymers.

As used herein, a “tackifier resin component” is understood in line with the general understanding of the skilled person to be an oligomeric or polymeric resin which increases the adhesion (the tack, the intrinsic stickiness) of the pressure-sensitive adhesive layer by comparison with the otherwise identical pressure-sensitive adhesive layer containing no tackifier resin component.

The tackifier resin component (b) preferably has a weight-average molecular weight Mw, determined according to Test Method 1 (see below), in a range from 400 to 15 000 g/mol, more preferably in a range from 400 to 5000 g/mol, more preferably in a range from 500 to 2000 g/mol. The tackifier resin component (b) preferably comprises one or more materials selected from the group consisting of unhydrogenated or partially or fully hydrogenated resins based on rosin or rosin derivatives, hydrogenated polymers of dicyclopentadiene, unhydrogenated or partially, selectively or fully hydrogenated hydrocarbon resins based on C-5, C-5/C-9 or C-9 monomer mixtures, and polyterpene resins based on α-pinene and/or β-pinene and/or δ-limonene. The tackifier resin component (b) may be used either alone or in a mixture. The plasticizing resin component (c) preferably has a softening temperature of <30° C., determined according to Test Method 2 (see below). The plasticizing resin component (c) preferably comprises a rosin-based, a hydrocarbon-based or polyterpene-based plasticizing resin.

The first pressure-sensitive adhesive layer (i) and/or the second pressure-sensitive adhesive layer (iv) preferably comprises the plasticizing resin component (c) in a range from 0.1 to 15 wt %, more preferably 2 to 10 wt %.

The first pressure-sensitive adhesive layer (i) and/or the second pressure-sensitive adhesive layer (iv) preferably additionally comprises additives (d). The additives (d) preferably comprise one or more materials selected from the group consisting of light stabilizers, flame retardants, fillers, dyes, pigments, plasticizing agents, antioxidants, process stabilizers, processing assistants and endblock reinforcer resins.

The pressure-sensitive adhesive layer (i) and/or (iv) may have any desired colouring or be white, grey or black.

These or other, further additives (d) that may be utilized are typically as follows:
light stabilizers such as, for example, UV absorbers or sterically hindered amines, preferably with a fraction of 0.2 to 1 wt %, based on the total weight of the pressure-sensitive adhesive layer,
plasticizing agents such as, for example, low molecular weight liquid polymers, such as, for example, low molecular weight polybutenes, preferably with a fraction of 0.2 to less than 5 wt %, based on the total weight of the pressure-sensitive adhesive layer,
antioxidants, such as, for example, primary antioxidants such as, for example, sterically hindered phenols, preferably with a fraction of 0.2 to 1 wt %, based on the total weight of the pressure-sensitive adhesive layer, and such as, for example, secondary antioxidants, such as, for example, phosphites or thioethers, preferably with a fraction of 0.2 to 1 wt %, based on the total weight of the pressure-sensitive adhesive layer,
process stabilizers such as, for example, C radical scavengers, preferably with a fraction of 0.2 to 1 wt %, based on the total weight of the pressure-sensitive adhesive layer,
processing assistants, preferably with a fraction of 0.2 to 1 wt %, based on the total weight of the pressure-sensitive adhesive layer,
endblock reinforcer resins, if desired preferably with a fraction of 0.2 to 10 wt %, based on the total weight of the pressure-sensitive adhesive layer,
optionally further polymers, preferably elastomeric in nature; elastomers utilizable accordingly include those based on pure hydrocarbons, for example unsaturated polydienes such as natural or synthetically generated polyisoprene or polybutadiene, chemically substantially saturated elastomers such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, allyl or vinyl ether-containing polyolefins, preferably with a fraction of 0.2 to 10 wt %, based on the total weight of the pressure-sensitive adhesive layer. The nature and amount of the additives (d) may be selected according to requirement. It is also in accordance with the invention if the adhesive layer (i) and/or (iv) in each case does not have some or even all of the stated additives (d).

With regard to the thickness of the pressure-sensitive adhesive layer (i) and/or (iv), there are in principle no particular restrictions. The first pressure-sensitive adhesive layer (i) and/or the second pressure-sensitive adhesive layer (iv) preferably has a thickness in a range from 25 to 3000 μm, more preferably in a range from 50 μm to 1000 μm. In the laminate, the first pressure-sensitive adhesive layer (i) and the second pressure-sensitive adhesive layer (iv) are preferably identical in terms of their composition. Alternatively, they may differ in terms of their composition. Moreover, in the laminate, the first pressure-sensitive adhesive layer (i) and the second pressure-sensitive adhesive layer (iv) preferably have the same thickness. Alternatively, they may differ in terms of their thickness.

Preferably, the first pressure-sensitive adhesive layer (i) and/or the second pressure-sensitive adhesive layer (iv) is a pressure-sensitive adhesive layer that is detachable by stretching in the bond plane direction. The first pressure-sensitive adhesive layer (i) and/or the second pressure-sensitive adhesive layer (iv) is self-adhesive, highly extensible and to a large part elastic, and may be detached without residue or destruction by extensive stretching in the bond plane direction. This property is also referred to as detachability. To allow detachable pressure-sensitive adhesive layers to be detached easily and without residue, they are required to possess certain technical adhesive properties: on stretching, the tack of the pressure-sensitive adhesive layer must drop significantly. The lower the bonding performance in the stretched state, the less the extent to which the substrate is damaged during detachment. Further statements relating to the pressure-sensitive adhesive layer are disclosed in EP Patent No. 3578618B1, published on Mar. 2, 2022, the salient portions of which are hereby incorporated by reference within this disclosure.

The first pressure-sensitive adhesive layer (i) and/or the second pressure-sensitive adhesive layer (iv) preferably has an elongation at break of at least 100%, determined according to Test Method 3 (see below), and a resilience of more than 50%, as determined according to Test Method 4 (see below).

The metal layer (ii) preferably comprises one or more materials selected from the group consisting of aluminium, copper, nickel, iron and steel, more preferably aluminium and copper. With regard to the thickness of the metal layer (ii), there are in principle no particular limitations. The metal layer (ii) preferably has a thickness in a range from 1 to 200 μm, more preferably in a range from 5 to 100 μm.

The metal layer (ii) preferably additionally comprises a carrier, the carrier comprising one or more materials selected from the group consisting of polyethylene terephthalate, polyethylene and polypropylene, preferably polyethylene terephthalate. When a carrier is present, the blowing agent layer (iii) is disposed preferably on the side of the metal layer (ii).

The metal layer (ii) may preferably be heated inductively. With further preference, the metal layer (ii) may be heated to a temperature in a range from 50 to 200° C., more preferably in a range from 70 to 180° C., in a magnetic field with a frequency in a range from 100 Hz to 200 kHz, preferably in a range from 5 kHz to 50 kHz, more preferably in a range from 10 kHz to 30 kHz, further preferably for a duration in a range from 1 to 20 s, more preferably in a range from 5 to 15 s.

The blowing agent layer (iii) preferably comprises one or more materials selected from the group consisting of azo compounds, hydrazine compounds, sulfonylsemicarbazide compounds, tetrazole compounds, N-nitroso compounds and carbonate compounds.

The blowing agent layer (iii) preferably comprises expandable, thermoplastic microspheres. The expandable, thermoplastic microspheres preferably comprise a thermoplastic polymer shell and a blowing agent enclosed therein. Expandable, thermoplastic microspheres, also microballoons or microbeads, are available commercially for example under the brand name EXPANCEL®. The blowing agent in such microspheres is generally a liquid having a boiling point not higher than the softening temperature of the thermoplastic polymer shell. The softening temperature of the polymer shell, normally corresponding to its glass transition temperature T_{g}, is preferably within the range from 0 to 140° C., more preferably from 30 to 100° C. On heating, the blowing agent evaporates, with the internal pressure increasing at the same time, and with simultaneous softening of the shell, leading to a considerable increase in the size of the microspheres. The temperature at which the expansion begins is called Tₛₜₐᵣₜ, while the temperature at which maximum expansion is attained is referred to as Tₘₐₓ. For the expandable, thermoplastic microspheres, T start is preferably from 40 to 140° C., most preferably from 50 to 100° C. Tₘₐₓ of the expandable, thermoplastic microspheres is higher than Tₛₜₐᵣₜ and preferably from 80 to 200° C., more preferably from 100 to 170° C.

With regard to the thickness of the blowing agent layer (iii), there are in principle no particular limitations. The blowing agent layer (iii) preferably has a thickness in a range from 10 to 150 μm, more preferably in a range from 25 to 100 μm.

With particular preference, the blowing agent layer (iii) contains expandable, thermoplastic microspheres which in the unexpanded state at 25° C. have a mean diameter of 3 μm to 30 μm, more preferably of 5 μm to 20 μm, and/or which after expansion have a mean diameter of 10 μm to 200 μm, preferably of 15 μm to 90 μm. The mean diameter of the unexpanded microspheres is preferably below the layer thickness of the blowing agent layer (iii).

The blowing agent layer (iii) preferably comprises at least 50 wt %, more preferably at least 90 wt %, of a thermoplastic polyurethane. The thermoplastic polyurethane preferably comprises at least one polyisocyanate component and at least one polyol component. The thermoplastic polyurethane preferably comprises a thermoplastic polyurethane dispersion. Polyurethane dispersions which may be employed for the purposes of the present invention include in particular the following dispersions, optionally in combination:
anionically stabilized aliphatic polyester-polyurethane dispersions (dispersions based on polyester and aliphatic anionic isocyanate-polyurethane). These include the following products sold by Covestro AG: Impranil® LP RSC 1380, DL 1537 XP, DL 1554 XP,
anionically stabilized aliphatic polyether-polyurethane dispersions. These include the following products sold by Covestro AG: Impranil® 25 LP DSB 1069,
anionically stabilized aliphatic polycarbonate-polyester-polyurethane dispersions. These include the following products sold by Covestro AG: Impranil® DLU, and
anionically stabilized polycarbonate-polyurethane dispersions. These include the following products sold by Covestro AG: Impranil® DL 2288 XP.

The thermoplastic polyurethane is preferably preparable from a polymerization mixture containing at least one diisocyanate, at least one polyester polyol and optionally at least one alkanediol.

The at least one diisocyanate is preferably selected from the group consisting of toluene diisocyanate (TDI), p-phenylene diisocyanate (PPDI), 4,4′-diphenylmethane diisocyanate (MDI), p,p′-bisphenyl diisocyanate (BPDI), isophorone diisocyanate (IPDI), 1,6-hexamethylene diisocyanate (HDI), or 4,4′-diisocyanatodicyclohexylmethane (H12MDI), preferably toluene diisocyanate (TDI). Also suitable are diisocyanates having substituents in the form of halo, nitro, cyano, alkyl, alkoxy, haloalkyl, hydroxyl, carboxyl, amido, amino or combinations thereof. It is also possible to employ all aliphatic, cycloaliphatic, araliphatic and, preferably, the aromatic polyfunctional isocyanates that are known per se.

Specific examples include: alkylene diisocyanates having 4 to 12 carbon atoms in the alkylene radical, such as 1,12-dodecane diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates, such as cyclohexane 1,3-diisocyanate and cyclohexane 1,4-diisocyanate and any desired mixtures of these isomers, 1-isocyanato-3,3,5-trimethyl-5-isocyanatomethylcyclohexane (isophorone diisocyanate), 2,4- and 2,6-hexahydrotolylene diisocyanate and any desired mixtures of these isomers, 4,4′-, 2,4′- and 2,2′-dicyclohexylmethane diisocyanate and any desired mixtures of these isomers, and preferably aromatic di- and polyisocyanates, such as, for example, 2,4- and 2,6-tolylene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenylpolymethylene polyisocyanates, mixtures of 4,4′-, 2,4′- and 2,2′-diphenylmethane diisocyanates and polyphenylpolymethylene polyisocyanates (crude MDI), and mixtures of crude MDI and tolylene diisocyanates. The organic di- and polyisocyanates may be used individually or in the form of their mixtures.

The polyisocyanate component preferably has a number-average molecular weight Mₙ, determined according to Test Method 1, in a range from 60 to 50 000 g/mol, more preferably in a range from 400 to 10 000 g/mol, more preferably in a range from 400 to 6000 g/mol.

Also frequently used are what are called modified polyfunctional isocyanates, these being products obtained by chemical reaction of organic di- and/or polyisocyanates. Examples include di- and/or polyisocyanates containing ester, urea, biuret, allophanate, carbodiimide, isocyanurate, uretdione and/or urethane groups. Examples of those contemplated specifically are as follows: organic, preferably aromatic polyisocyanates containing urethane groups, having NCO contents of 33.6 to 15 wt %, preferably of 31 to 21 wt %, based on the total weight. Examples are 2,4- or 2,6-tolylene diisocyanate or crude MDI modified with low molecular weight diols, triols, dialkylene glycols, trialkylene glycols or polyoxyalkylene glycols having number-average molecular weights of up to 6000 g/mol, more particularly up to 1500 g/mol. Examples of suitable di- or polyoxyalkylene glycols are diethylene, dipropylene, polyoxyethylene, polyoxypropylene and polyoxypropylene-polyoxyethylene glycols, triols and/or tetrols. Also suitable are prepolymers containing NCO groups, having NCO contents of 25 to 3.5 wt %, preferably of 21 to 14 wt %, based on the total weight, prepared from polyester polyols and/or preferably polyether polyols and from 4,4′-diphenylmethane diisocyanate, mixtures of 2,4′- and 4,4′-diphenylmethane diisocyanate, 2,4- and/or 2,6-tolylene diisocyanate or crude MDI. Also established are liquid polyisocyanates containing carbodiimide groups and/or isocyanurate rings, having NCO contents of 33.6 to 15 wt %, preferably 31 to 21 wt %, based on the total weight, being based for example on 4,4′-, 2,4′- and/or 2,2′-diphenylmethane diisocyanate and/or 2,4- and/or 2,6-tolylene diisocyanate.

The modified polyisocyanates may be mixed with one another or with unmodified organic polyisocyanates such as, for example, 2,4′-, 4,4′-diphenylmethane diisocyanate, crude MDI, 2,4- and/or 2,6-tolylene diisocyanate.

Particularly established as isocyanates are diphenylmethane diisocyanate isomer mixtures or crude MDI and especially crude MDI having a diphenylmethane diisocyanate isomer content of 30 to 55 wt %, and also polyisocyanate mixtures containing urethane groups and based on diphenylmethane diisocyanate, with an NCO content of 15 to 33 wt %.

The polyol component preferably comprises one or more materials selected from the group consisting of alkanediols, polyetherdiols, polyesterdiols, polycarbonatediols, polycaprolactone polyols and polyacrylate polyols, preferably polyetherdiols, polyesterdiols and polycarbonatediols. More preferably the polyol component comprises one or more materials selected from the group consisting of glycol, propanediol, butanediol, pentanediol, hexanediol, cyclohexanediol, cyclohexyldimethanol, octanediol, neopentyl glycol, diethylene glycol, triethylene glycol, trimethylpentanediol, benzenedimethanol, benzenediol, methylbenzenediol, bisphenol A, poly(butanediol-co-adipate) glycol, poly(hexanediol-co-adipate) glycol, poly(ethanediol-co-adipate) glycol, polytetramethylene glycol, polypropylene glycol, and polyethylene glycol, preferably butanediol.

The polyol component preferably has a number-average molecular weight Mₙ, determined according to Test Method 1, in a range from 60 to 50 000 g/mol, more preferably in a range from 400 to 10 000 g/mol, more preferably in a range from 400 to 6000 g/mol. Further statements relating to the blowing agent layer (iii) are disclosed in German Patent Application Publication No. DE102020210503A1, published on Feb. 24, 2022, the salient portions of which are hereby incorporated by reference within this disclosure. Further, the blowing agent layer (iii) is preferably detachable at a temperature in a range from 40 to 200° C., more preferably in a range from 50 to 120° C.

The present invention further relates to a method for producing the laminate as described herein, wherein the first pressure-sensitive adhesive layer (i) and/or the second pressure-sensitive adhesive layer (iv) is applied by direct coating or by lamination, preferably hot lamination. Here, the blowing agent layer (iii) is preferably coated directly onto the metal layer (ii).

The blowing agent layer (iii) may be coated either from solution or from dispersion onto the metal layer (ii). The blowing agent layer may be applied using knife coating methods, die knife coating methods, rolling-rod die methods, extrusion die methods, casting die methods and casting methods. Likewise in accordance with the invention are application methods such as roll application methods, printing methods, screen-printing methods, halftone roll methods, ink-jet methods and spraying methods. While application from hotmelt is possible, it must be ensured that the coating temperature is lower than the temperature needed for expanding the layer.

If the metal layer (ii) contains a further layer, such as a plastics layer for improved processing, the blowing agent layer (iii) ought to be coated onto the metal side in order to obtain more effective heat transfer. Transfer coating, first to a liner and lamination to the metal layer (ii), is possible only if the blowing agent layer (iii) possesses a certain tack.

The pressure-sensitive adhesive layer (i) and/or (iv) may be produced and processed either from solution or from the melt. The pressure-sensitive adhesive layer may be applied by direct coating or by lamination, especially hot lamination. The pressure-sensitive adhesive layer may be applied using knife coating methods, die knife coating methods, rolling-rod die methods, extrusion die methods, casting die methods and casting methods. Likewise in accordance with the invention are application methods such as roll application methods, printing methods, screen-printing methods, halftone roll methods, ink-jet methods and spraying methods. Hotmelt processes (extrusion, die) are preferred.

Here, the coating may take place either directly onto the metal layer (ii) or onto the blowing agent layer (iii), or coating takes place first onto a liner and then the adhesive is applied by lamination to the metal layer (ii) or to the blowing agent layer (iii).

Liners in this context may be films or papers with a non-stick coating. Siliconized films are frequently used as liners. Coating onto a liner and subsequent lamination onto the metal layer (ii) or blowing agent layer (iii) has the advantage that in this operation neither the blowing agent layer (iii) nor the metal layer (ii) need be subjected to an elevated temperature.

Optionally, further layers or plies of material are laminated on or coated subsequently in-line or off-line, allowing multilayer/multi-ply product constructions to be produced as well.

The present invention further relates to an arrangement comprising the laminate as described herein and at least one substrate, preferably at least two substrates; more preferably, the laminate as described herein is located between two substrates.

The present invention further relates to a method for detaching the laminate as described herein, comprising:
exposing the arrangement as described herein to inductive heating in an alternating magnetic field having a frequency in a range from 100 Hz to 200 kHz, preferably in a range from 5 kHz to 50 kHz, more preferably in a range from 10 kHz to 30 kHz; and/or
exposing the arrangement as described herein to a temperature in a range from 40 to 200° C., preferably from 50 to 120° C.; and
separating the laminate, e.g., detaching the laminate from at least one substrate, preferably from at least two substrates.

The separating preferably comprises an expansion of the blowing agent layer (iii). After the laminate has been parted by the expansion of the blowing agent layer (iii), there are residues of laminate with the metal layer (ii) on one substrate and residues of laminate without the metal layer (ii) on the other substrate.

The remaining adhesive parts of the laminate on the side with the metal layer (ii) can easily be removed by peeling. The metal layer (ii) ensures that the plies of the laminate are strong enough not to tear during peeling. The particular nature of the pressure-sensitive adhesive layer (i) and/or (iv), by virtue of the high cohesion, ensures that no remnants of adhesive remain on the substrate.

The other side, without the metal layer (ii), can easily be removed by extensive stretching. The extensive stretching causes a decrease in the bond strength of the pressure-sensitive adhesive layer (i) and/or (iv), including the residues of the blowing agent layer (iii), allowing the remaining laminate residues to be removed without remnant.

The possibility of removing the laminate without residue removes the need for a substantial cleaning effort, if the substrates are to be reutilized. Renewed bonding is possible without cleaning effort or with only very low cleaning effort.

The separating also preferably comprises an extensive stretching in the direction of the bond plane of the first pressure-sensitive adhesive layer (i) and/or of the second pressure-sensitive adhesive layer (iv). Through the extensive stretching in the direction of the bond plane, it is possible with preference to loosen the adhesive residues of the first pressure-sensitive adhesive layer (i) and/or of the second pressure-sensitive adhesive layer (iv) from the substrate without residue or virtually without residue.

The present invention further relates to the use of the laminate as described herein in electronic devices, motor vehicles, medical devices and dental devices.

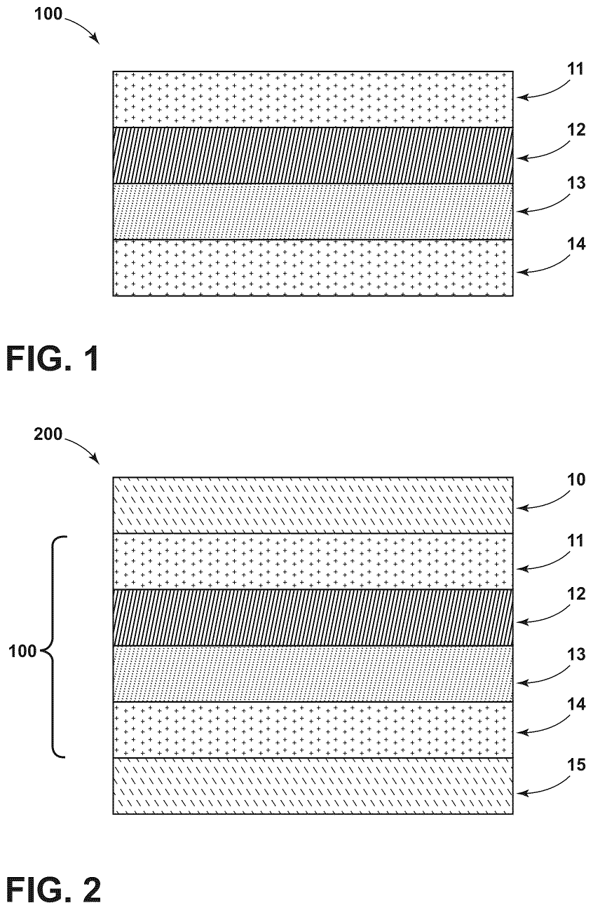

Referring now to FIG. 1, this figure shows a laminate 100 according to one or more embodiments of the present disclosure, comprising a first pressure-sensitive adhesive layer 11, a metal layer 12, a blowing agent layer 13 and a second pressure-sensitive adhesive layer 14 (e.g., a first pressure-sensitive adhesive layer (i), a metal layer (ii), a blowing agent layer (iii), and a second pressure-sensitive adhesive layer (iv), as described earlier).

Referring now to FIG. 2, this figure shows an arrangement 200 according to one or more embodiments of the disclosure, comprising two substrates 10 and 15, and a laminate 100, which includes a first pressure-sensitive adhesive layer 11, a metal layer 12, a blowing agent layer 13 and a second pressure-sensitive adhesive layer 14. As depicted in FIG. 2, the laminate 100 is disposed between the first and second substrates 10 and 15, respectively.

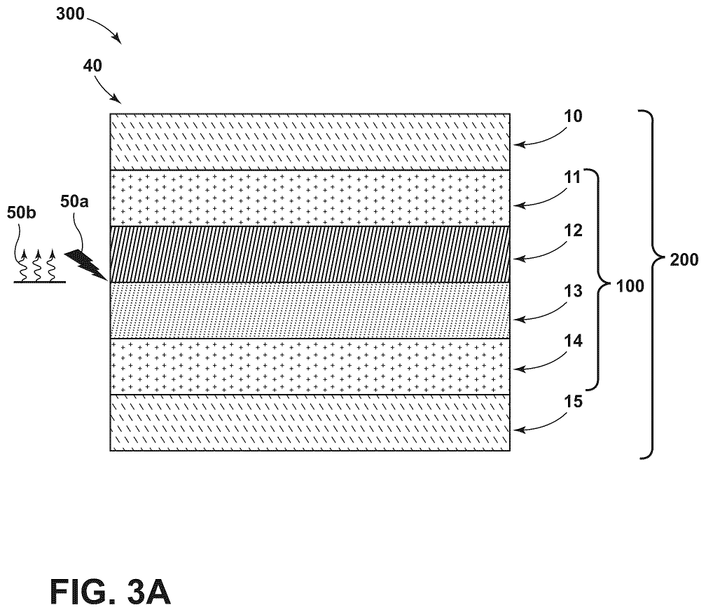

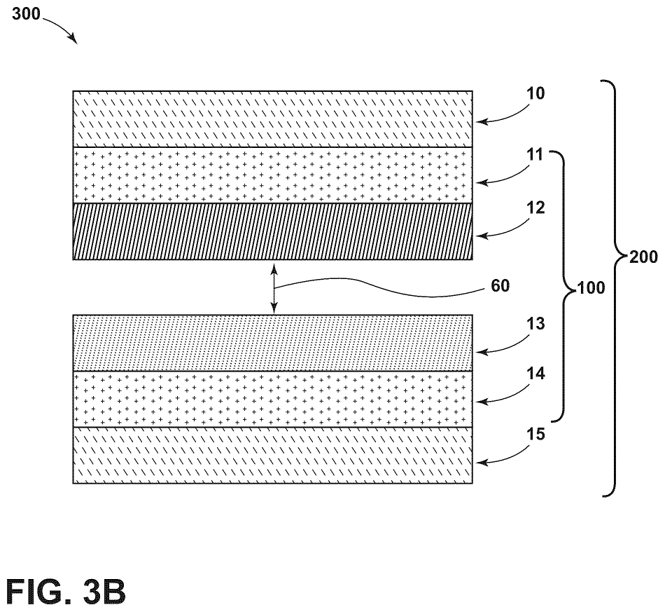

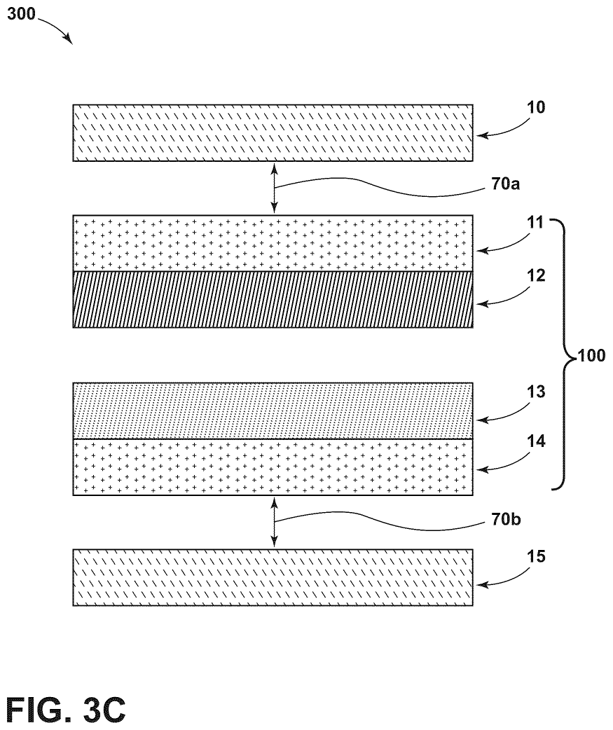

Referring now to FIGS. 3A-3C, these figures show a method 300 for detaching a laminate 100 (e.g., as depicted in FIGS. 1 and 2), according to one or more embodiments of the disclosure. The method 300 includes a step 40 (see FIG. 3A) of providing an arrangement (e.g., an arrangement 200 as shown in FIG. 2), the arrangement comprising a laminate (e.g., a laminate 100 as shown in FIG. 1), a first substrate 10 and a second substrate 15, wherein the laminate is disposed between the substrates 10, 15. The method 300 includes a step 50a and/or 50b of exposing the arrangement to a temperature in a range from 40 to 200° C. (see FIG. 3A). Further, the method 300 includes a step 60 of separating the laminate (see FIG. 3B). As depicted in exemplary form in FIG. 3B, the step 60 shows that the separating takes place between the metal layer 12 and the blowing agent layer 13 in a magnetic field.

In some embodiments of the method 300, as shown in FIGS. 3B and 3C, the step 60 of separating the laminate includes steps 70a and/or 70b of detaching the laminate from the substrate 10 and/or substrate 15, respectively. As shown in FIG. 3A, the step 50a of exposing the arrangement comprises subjecting the arrangement to inductive heating in an alternating magnetic field having a frequency in a range from 100 Hz to 200 kHz. In some embodiments, the step 50a of exposing the arrangement can comprise subjecting the metal layer 12 of the laminate to inductive heating to a temperature in a range from 50 to 200° C. by an alternating magnetic field having a frequency in a range from 10 kHz to 30 kHz for a duration in a range from 1 to 20 s. According to another embodiment, as also shown in FIG. 3A, the step 50b of exposing the arrangement comprises heating the arrangement to a temperature in a range from 50 to 200° C.

The present invention as described above is further described by the following set of embodiments and combinations of embodiments, with the combinations arising from the corresponding dependency references and back-references. It may be noted in particular that at those places at which a range of embodiments is mentioned—as for example in connection with an expression such as “laminate according to any of Embodiments 1 to 5”—each individual embodiment in this range is disclosed as explicit to the skilled person, with the skilled person therefore understanding this expression to be synonymous with the expression “laminate according to one of the Embodiments 1, 2, 3, 4 and/or 5”. It may also be noted explicitly that the following set of Embodiments represents not the set of claims that determine the scope of protection, but rather a suitably structured part of the description which is directed to general and preferred aspects of the present invention.

Embodiment 1. Laminate comprising layers as follows:
(i) a first pressure-sensitive adhesive layer, comprising a block copolymer containing at least one polymer block formed from vinylaromatics and at least one polymer block formed from alkenes;
(ii) a metal layer;
(iii) a blowing agent layer; and
(iv) a second pressure-sensitive adhesive layer, comprising a block copolymer containing at least one polymer block formed from vinylaromatics and at least one polymer block formed from alkenes.

Embodiment 2. Laminate according to Embodiment 1, wherein the first pressure-sensitive adhesive layer (i) and/or the second pressure-sensitive adhesive layer (iv) comprises an elastomer component (a), a tackifier resin component (b) and optionally a plasticizing resin component (c), preferably an elastomer component (a), a tackifier resin component (b) and a plasticizing resin component (c).

Embodiment 3. Laminate according to Embodiment 2, wherein the elastomer component (a) comprises a block copolymer having an A-B-A, (A-B)ₙ, (A-B)ₙX or (A-B-A)ₙX construction, preferably a diblock copolymer A-B and/or a triblock copolymer A-B-A, in which
the blocks A independently of one another comprise a polymer preparable from a polymerization mixture containing vinylaromatic monomers having 8 to 12 carbon atoms;
the blocks B independently of one another comprise a polymer preparable from a polymerization mixture containing alkene monomers having 4 to 18 carbon atoms;
X comprises a radical of a coupling reagent or initiator; and
n≥2.

Embodiment 4. Laminate according to Embodiment 3, wherein the blocks A are preparable from a polymerization mixture containing styrene and α-methylstyrene, preferably preparable from a polymerization mixture containing styrene.

Embodiment 5. Laminate according to Embodiment 3 or 4, wherein the blocks B are preparable from a polymerization mixture containing monomers of 1,3-dienes and isobutylene, preferably preparable from a polymerization mixture containing butadiene and/or isoprene.

Embodiment 6. Laminate according to any of Embodiments 3 to 5, wherein the blocks A have a fraction in the block copolymer in a range from 14 to 35 wt %, preferably in a range from 14 to 30 wt %.

Embodiment 7. Laminate according to any of Embodiments 3 to 6, wherein the blocks B have a fraction in the block copolymer in a range from 65 to 86 wt %.

Embodiment 8. Laminate according to any of Embodiments 2 to 7, wherein the tackifier resin component (b) has a weight-average molecular weight M_{W}, determined according to Test Method 1, in a range from 400 to 15 000 g/mol, preferably in a range from 400 to 5000 g/mol, more preferably in a range from 500 to 2000 g/mol.

Embodiment 9. Laminate according to any of Embodiments 2 to 8, wherein the tackifier resin component (b) comprises one or more materials selected from the group consisting of unhydrogenated or partially or fully hydrogenated resins based on rosin or rosin derivatives, hydrogenated polymers of dicyclopentadiene, unhydrogenated or partially, selectively or fully hydrogenated hydrocarbon resins based on C-5, C-5/C-9 or C-9 monomer mixtures, and polyterpene resins based on α-pinene and/or 0-pinene and/or 8-limonene.

Embodiment 10. Laminate according to any of Embodiments 2 to 9, wherein the plasticizing resin component (c) has a softening temperature of <30° C., determined according to Test Method 2.

Embodiment 11. Laminate according to any of Embodiments 2 to 10, wherein the plasticizing resin component (c) comprises a rosin-based, a hydrocarbon-based or polyterpene-based plasticizing resin.

Embodiment 12. Laminate according to any of Embodiments 2 to 11, wherein the first pressure-sensitive adhesive layer (i) and/or the second pressure-sensitive adhesive layer (iv) comprises the plasticizing resin component (c) in a range from 0.1 to 15 wt %, preferably in a range from 2 to 10 wt %.

Embodiment 13. Laminate according to any of Embodiments 1 to 12, wherein the first pressure-sensitive adhesive layer (i) and/or the second pressure-sensitive adhesive layer (iv) additionally comprises additives (d).

Embodiment 14. Laminate according to Embodiment 13, wherein the additive (d) comprises one or more materials selected from the group consisting of light stabilizers, flame retardants, fillers, dyes, pigments, plasticizing agents, antioxidants, process stabilizers, processing assistants and endblock reinforcer resins.

Embodiment 15. Laminate according to any of Embodiments 1 to 14, wherein the first pressure-sensitive adhesive layer (i) and/or the second pressure-sensitive adhesive layer (iv) has a thickness in a range from 25 to 3000 μm, preferably in a range from 50 μm to 1000 μm.

Embodiment 16. Laminate according to any of Embodiments 1 to 15, wherein the first pressure-sensitive adhesive layer (i) and/or the second pressure-sensitive adhesive layer (iv) is a pressure-sensitive adhesive layer that is detachable by stretching in the bond plane direction.

Embodiment 17. Laminate according to any of Embodiments 1 to 16, wherein the first pressure-sensitive adhesive layer (i) and/or the second pressure-sensitive adhesive layer (iv) has an elongation at break of at least 100%, determined according to Test Method 3, and a resilience of more than 50%, determined according to Test Method 4.

Embodiment 18. Laminate according to any of Embodiments 1 to 17, wherein the metal layer (ii) comprises one or more materials selected from the group consisting of aluminium, copper, nickel, iron and steel, preferably aluminium and copper.

Embodiment 19. Laminate according to any of Embodiments 1 to 18, wherein the metal layer (ii) has a thickness in a range from 1 to 200 μm, preferably in a range from 5 to 100 μm.

Embodiment 20. Laminate according to any of Embodiments 1 to 19, wherein the metal layer (ii) additionally comprises a carrier, the carrier comprising one or more materials selected from the group consisting of polyethylene terephthalate, polyethylene and polypropylene, preferably polyethylene terephthalate.

Embodiment 21. Laminate according to any of Embodiments 1 to 20, wherein the metal layer of (ii) may be heated inductively; further preferably, the metal layer (ii) may be heated to a temperature in a range from 50 to 200° C., more preferably in a range from 70 to 180° C., in a magnetic field with a frequency in a range from 100 Hz to 200 kHz, preferably in a range from 5 kHz to 50 kHz, more preferably in a range from 10 kHz to 30 kHz, further preferably for a duration in a range from 1 to 20 s, more preferably in a range from 5 to 15 s.

Embodiment 22. Laminate according to any of Embodiments 1 to 21, wherein the blowing agent layer (iii) comprises one or more materials selected from the group consisting of azo compounds, hydrazine compounds, sulfonylsemicarbazide compounds, tetrazole compounds, N-nitroso compounds and carbonate compounds.

Embodiment 23. Laminate according to any of Embodiments 1 to 22, wherein the blowing agent layer (iii) comprises expandable, thermoplastic microspheres.

Embodiment 24. Laminate according to Embodiment 23, wherein the expandable, thermoplastic microspheres comprise a thermoplastic polymer shell and a blowing agent enclosed therein.

Embodiment 25. Laminate according to any of Embodiments 1 to 24, wherein the blowing agent layer (iii) has a thickness in a range from 10 to 150 μm, preferably in a range from 25 to 100 μm.

Embodiment 26. Laminate according to any of Embodiments 1 to 25, wherein the blowing agent layer (iii) comprises at least 50 wt %, preferably at least 90 wt %, of a thermoplastic polyurethane.

Embodiment 27. Laminate according to Embodiment 26, wherein the thermoplastic polyurethane comprises at least one polyisocyanate component and at least one polyol component.

Embodiment 28. Laminate according to Embodiment 26 or 27, wherein the thermoplastic polyurethane comprises a thermoplastic polyurethane dispersion.

Embodiment 29. Laminate according to any of Embodiments 26 to 28, wherein the thermoplastic polyurethane is preparable from a polymerization mixture comprising at least one diisocyanate, at least one polyester polyol and optionally at least one alkanediol.

Embodiment 30. Laminate according to Embodiment 29, wherein the at least one diisocyanate is selected from the group consisting of toluene diisocyanate (TDI), p-phenylene diisocyanate (PPDI), 4,4′-diphenylmethane diisocyanate (MDI), p,p′-bisphenyl diisocyanate (BPDI), isophorone diisocyanate (IPDI), 1,6-hexamethylene diisocyanate (HDI), or 4,4′-diisocyanatodicyclohexylmethane (H12MDI), preferably toluene diisocyanate (TDI).

Embodiment 31. Laminate according to any of Embodiments 27 to 30, wherein the polyisocyanate component has a number-average molecular weight Mₙ, determined according to Test Method 1, in a range from 60 to 50 000 g/mol, preferably in a range from 400 to 10 000 g/mol, more preferably in a range from 400 to 6000 g/mol.

Embodiment 32. Laminate according to any of Embodiments 27 to 31, wherein the polyol component comprises one or more materials selected from the group consisting of alkanediols, polyetherdiols, polyesterdiols, polycarbonatediols, polycaprolactone polyols and polyacrylate polyols, preferably polyetherdiols, polyesterdiols and polycarbonatediols.

Embodiment 33. Laminate according to Embodiment 32, where the polyol component comprises one or more materials selected from the group consisting of glycol, propanediol, butanediol, pentanediol, hexanediol, cyclohexanediol, cyclohexyldimethanol, octanediol, neopentyl glycol, diethylene glycol, triethylene glycol, trimethylpentanediol, benzenedimethanol, benzenediol, methylbenzenediol, bisphenol A, poly(butanediol-co-adipate) glycol, poly(hexanediol-co-adipate) glycol, poly(ethanediol-co-adipate) glycol, polytetramethylene glycol, polypropylene glycol, and polyethylene glycol, preferably butanediol.

Embodiment 34. Laminate according to any of Embodiments 27 to 33, wherein the polyol component has a number-average molecular weight Mₙ, determined according to Test Method 1, in a range from 60 to 50 000 g/mol, preferably in a range from 400 to 10 000 g/mol, more preferably in a range from 400 to 6000 g/mol.

Embodiment 35. Laminate according to any of Embodiments 1 to 34, wherein the blowing agent layer (iii) is detachable at a temperature in a range from 40 to 200° C., preferably from 50 to 120° C.

Embodiment 36. Method for producing the laminate according to any of Embodiments 1 to 35, wherein the first pressure-sensitive adhesive layer (i) and/or the second pressure-sensitive adhesive layer (iv) is applied by direct coating or by lamination, preferably hot lamination.

Embodiment 37. Arrangement comprising the laminate according to any of Embodiments 1 to 35 and at least one substrate, preferably at least two substrates; further preferably, the laminate according to any of Embodiments 1 to 35 is located between two substrates.

Embodiment 38. Method for detaching the laminate according to any of Embodiments 1 to 35, comprising:
exposing the arrangement according to Embodiment 37 to inductive heating in an alternating magnetic field having a frequency in a range from 100 Hz to 200 kHz, preferably in a range from 5 kHz to 50 kHz, more preferably in a range from 10 kHz to 30 kHz; and/or
exposing the arrangement according to Embodiment 37 to a temperature in a range from 40 to 200° C., preferably in a range from 50 to 120° C.; and
separating the laminate, the separating comprising detaching the laminate from at least one substrate, preferably from at least two substrates.

Embodiment 39. Method according to Embodiment 38, wherein the separating comprises an expansion of the blowing agent layer (iii).

Embodiment 40. Method according to Embodiment 39, wherein the separating comprises an extensive stretching in the direction of the bond plane of the first pressure-sensitive adhesive layer (i) and/or of the second pressure-sensitive adhesive layer (iv).

Embodiment 41. Method according to Embodiment 40, wherein the extensive stretching in the direction of the bond plane allows the residues of adhesive of the first pressure-sensitive adhesive layer (i) and/or of the second pressure-sensitive adhesive layer (iv) to be removed from the substrate without residue or virtually without residue.

Embodiment 42. Use of the laminate according to any of Embodiments 1 to 35 in electronic devices, motor vehicles, medical devices and dental devices.

### EXAMPLES

Further details and features of the present invention are apparent from the description of working examples. Here, the respective features may be realized on their own or as two or more in combination with one another. The invention is not confined to the working examples.

Test Methods:

Test Method 1: Molecular Weight Mₙ and M_{w}

The data for the number-average molecular weight Mₙ and weight-average molecular weight M_{w} in this specification are based on determination by gel permeation chromatography (GPC). The determination takes place on 100 μl of sample having undergone clarifying filtration (sample concentration 3 g/1). The eluent used is tetrahydrofuran with 0.1 vol % of trifluoroacetic acid. Measurement takes place at 25° C. The pre-column used is a column of type PSS-SDV, 5 μm, 10³ Å, 8.0 mm*50 mm (data here and below in the following order: type, particle size, porosity, internal diameter*length; 1 Å=10⁻¹⁰ m). Separation is carried out using a combination of the columns of type PSS-SDV, 5 μm, 10³ Å and also 10⁵ Å and 10⁶ Å each with 8.0 mm*300 mm (columns from Polymer Standards Service; detection via Shodex RI71 differential refractometer). The flow rate is 1.0 ml per minute. Calibration takes place against PMMA standards (polymethyl methacrylate calibration) in the case of polar molecules such as, for example, the starting materials for the polyurethane, and against PS standards otherwise (polystyrene calibration).

Test Method 2: Softening Temperature

The softening temperature is carried out according to the relevant methodology, which is known as ring & ball and is standardized according to ASTM E28.

Test Method 3: Elongation at Break

The elongation at break was measured in accordance with DIN 53504 (2017-03) using dumbbell specimens of size S3 with a separation speed of 300 mm per minute. The test conditions were 23° C. and 50% relative humidity.

Test Method 4: Resilience

To measure the resilience, the pressure-sensitive adhesive strips were stretched by 100%, held with this stretch for 30 s, and then released. After a waiting time of 1 min, the length was measured again.

The resilience is then calculated as follows:

RE=((L₁₀₀−L_{end})/L₀)*100,
where RE=resilience in %
   L₁₀₀: length of the adhesive strip after stretching by 100%
   L₀: length of the adhesive strip prior to stretching
   L_{end}: length of the adhesive strip after relaxation for 1 min.
      Further, the resilience here corresponds to the elasticity.

Test Method 5: Glass Transition Temperature T_{g}

The glass transition temperature of polymers is determined via dynamic scanning calorimetry (DSC). For this determination, around 5 mg of the untreated polymer samples are weighed into a small aluminium crucible (volume 25 μl) and closed with a perforated lid. Measurement takes place using a DSC 204 F1 from Netzsch, operating under nitrogen for inertness. The sample is first cooled to −150° C., heated to +150° C. at a heating rate of 10 K/min, and cooled again to −150° C. The subsequent, second heating curve is run again at 10 K/min and the change in the heat capacity is recorded. Glass transitions are recognized as steps in the thermogram. The glass transition temperature is evaluated as follows: A tangent is applied in each case to the base line of the thermogram before 1 and after 2 of the step. In the region of the step, a line 3 of best fit is placed parallel to the ordinate in such a way as to intersect the two tangents, specifically so as to form two areas 4 and 5 (between the respective tangent, the line of best fit and the measurement plot) of equal area. The point of intersection of the line of best fit positioned accordingly and the measurement plot gives the glass transition temperature.

Test Method 6: Push-Out Test (z-Plane)

The push-out test provides information about the level of resistance of the bond of a component in a frame-shaped body, such as a window or a display in a housing, for example.

A rectangular, frame-shaped sample was cut out of the adhesive tape under investigation (external dimensions 33 mm×33 mm; border width 2.0 mm in each case; internal dimensions (window cutout) 29 mm×29 mm, bond area on top and bottom sides 248 mm² in each case). This sample was bonded to a rectangular PC plastic frame (PC=polycarbonate) (external dimensions 40 mm×40 mm; border width of the long borders 8 mm in each case; border width of the short borders 10 mm in each case; internal dimensions (window cutout) 24 mm×24 mm; thickness 3 mm). Bonded to the other side of the sample of the double-sided adhesive tape was a rectangular PC film with dimensions of 35 mm×35 mm. The full bond area of the adhesive tape available was utilized. PC frame, adhesive tape sample and PC window were bonded in such a way that their geometric centers, the bisecting lines of the acute diagonals and the bisecting lines of the obtuse diagonals of the rectangles, each lay on top of one another (corner on corner, long sides on long sides, short sides on short sides). The bond area was 248 mm². The bond was pressed at 248 N for 5 s and stored with conditioning at 23° C./50% relative humidity for 24 hours.

Immediately after storage, the bonded assembly composed of PC frame, adhesive tape and PC window was placed with the protruding edges of the PC frame onto a frame construction (sample holder) in such a way that the assembly was oriented horizontally and the PC window was oriented downwards in free suspension.

A pressure element is then moved perpendicularly from above through the window of the PC frame at a constant speed of 10 mm/s, so that it presses centrally onto the PC plate, and the respective force (determined from respective pressure and contact area between pressure element and plate) is measured as a function of the time from first contact of the pressure element with the PC plate up to shortly after the plate has dropped off (measuring conditions 23° C., 50% relative humidity). The push-out test response recorded is the force acting immediately before failure of the adhesive bond between PC plate and PC frame (maximum force Fₘₐₓ in the force-time diagram, in N).

Materials Used:

Elastomer Component:

Kraton™ D1152: styrene-butadiene-styrene elastomer consisting of primarily 2 and 3 styrene-butadiene blocks with a styrene fraction of 30% and a 2-block fraction of 15%, from Kraton Polymers LLC.

Europrene® Sol T 190: styrene-isoprene-styrene block copolymer consisting of primarily 2- and 3-blocks of styrene-isoprene with a styrene fraction of 16% and a 2-block fraction of 25%, from Versalis S.p.A.

Tackifier Resin Component:

Dercolyte A 115: terpene resin composed of primarily alpha-pinene with a softening point of 115° C., available from DRT.

Foralyn™ 110: rosin with a softening point of 110° C., available from the Eastman Chemical Company.

Regalite™ R1100: hydrogenated hydrocarbon resin based on C9 with a softening point of 100° C., available from the Eastman Chemical Company.

Plasticizing Resin Component:

Wingtack® 10: liquid resin based on unhydrogenated hydrocarbons, originally available from Goodyear and now Cray Valley.

Plasticizing Agent:

Ter Pib 2600: low molecular weight liquid polyisobutylene sold by Ter Hell GmbH.

Antioxidants:

Irganox® 1010: primary antioxidant from BASF Corporation.

Polyurethane Dispersion:

Impranil® DL 1116: anionically stabilized polyester-polyurethane (PU) dispersion from Covestro AG.

Microspheres:

Expancel® 920 DU 20: expandable, thermoplastic microspheres (microballoons) with a size after expansion of around 20 μm, from Nouryon.

### Example 1

Adhesive materials used for the first pressure-sensitive adhesive layer and/or the second pressure-sensitive adhesive layer were as follows:
48.5 wt % Kraton™ D 1152 styrene-butadiene-styrene elastomer;
48.5 wt % Dercolyte A 115 polyterpene resin;
2.5 wt % Wingtack® 10 tackifying resin; and
0.5 wt % Irganox® 1010 phenolic stabilizer.

The materials shown above were dissolved in toluene, the solids content being adjusted to 35 wt %. The resulting mixture was then coated out with a coating bar onto a PET liner, furnished with a silicone release, to produce after drying at 110° C. a layer thickness of 50 μm.

The blowing agent layer was produced using the following materials:
99.5 wt % Impranil® DL 1116 polyurethane dispersion; and
0.5 wt % Borchi® Gel 0625 thickener/rheology modifier.

The polyurethane dispersion was blended here with the thickener using a conventional vertical stirring apparatus with a Visco Jet stirrer.

Impranil® DL 1116 99.5 wt % and the thickener Borchi® Gel 0625 0.5 wt % were introduced in a container and cautiously stirred. The formation of vortices or any stirred introduction of air was to be avoided throughout the blending operation. Once a homogeneous mixture was formed, 20 parts of unexpanded microspheres (microballoons) (Expancel® 920 DU 20) were added to 100 parts of dispersion (calculated based on solids), with the addition taking place as a slurry in water.

Production of the Laminate:

The mixture thus obtained was then coated out with a knife coater onto an assembly of 12 μm aluminium and 12 μm PET, and dried, with the aluminium side of the assembly being coated. After drying at 110° C., at which the microballoons are not yet foamed, a layer thickness of 30 μm was obtained.

Subsequently, the polyurethane side of the blowing agent layer and the PET side of the newly formed assembly were each laminated with the adhesive for the pressure-sensitive adhesive layer. The result is a double-sided adhesive laminate with a layer thickness of around 155 μm.

This laminate was bonded between two PC (polycarbonate) surfaces as described in the push-out test. The push-out force was then measured. The laminate between the two PC plates was then stored in a magnetic field at 25 kHz for 10 s. The specimen was subsequently removed and the push-out force was measured again. The results are summarized below in Table 1.

After the separation of the two substrates, the residues of adhesive that remain were easily removed. The fracture takes place between the PU layer (blowing agent layer) and the aluminium layer. The remnants of the laminate with the aluminium layer were easily removable by peeling, with no residues of adhesive on the PC substrate.

The other side was easily removed by extensive stretching, by stretching the remaining residues of adhesive of the pressure-sensitive adhesive layer, including the polyurethane of the blowing agent layer, starting from one corner. Here again, the remnants could be removed without residue, allowing the PC elements to be used again without cleaning.

### Example 2

Adhesive materials used for the first pressure-sensitive adhesive layer and/or the second pressure-sensitive adhesive layer were as follows:
50 wt % Europrene® Sol T 190;
47 wt % Foralyn™ 110;
2.5 wt % Ter Pib 2600; and
0.5 wt % Irganox® 1010.

The materials shown above were dissolved in toluene, the solids content being adjusted to 40 wt %. The resulting mixture was then coated out with a coating bar onto a PET liner, furnished with a silicone release, to produce after drying at 110° C. a layer thickness of 50 μm. The blowing agent layer was the same as in Example 1.

The mixture thus obtained was then coated out with a knife coater onto a 20 μm thick aluminium foil, and dried. After drying at 110° C., at which the microspheres (microballoons) are not yet foamed, a layer thickness of 30 μm was obtained.

Subsequently, the polyurethane side of the blowing agent layer and the aluminium side of the newly formed assembly were each laminated with the adhesive for the pressure-sensitive adhesive layer. The result is a double-sided adhesive laminate with a layer thickness of around 150 μm.

This laminate was bonded between two PC (polycarbonate) surfaces as described in the push-out test. The push-out force was then measured. The laminate between the two PC plates was then stored in a magnetic field at 30 kHz for 5 s. The specimen was subsequently removed and the push-out force was measured again. The results are again found in Table 1.

After the separation of the two substrates, the residues of adhesive that remain were easily removed. The fracture takes place between the PU layer (blowing agent layer) and the aluminium layer. The remnants of the laminate with the aluminium layer were easily removable by peeling, with no residues of adhesive on the PC substrate.

The other side was easily removed by extensive stretching, by stretching the remaining residues of adhesive of the pressure-sensitive adhesive layer, including the polyurethane of the blowing agent layer, starting from one corner. Here again, the remnants could be removed without residue, allowing the PC elements to be used again without cleaning.

### Example 3

Adhesive materials used for the first pressure-sensitive adhesive layer and/or the second pressure-sensitive adhesive layer are as follows:
24 wt % Kraton™ D1152;
24 wt % Europrene® Sol T 190;
49 wt % Regalite™ R 1100;
2.5 wt % Wingtack® 10; and
0.5 wt % Irganox® 1010.

The materials shown above were dissolved in toluene, the solids content being adjusted to 35 wt %. The resulting mixture was then coated out with a coating bar onto a PET liner, furnished with a silicone release, to produce after drying at 110° C. a layer thickness of 50 μm. For the production of the blowing agent layer, the materials used are the same as in the previous examples, but with the addition of only 15 parts of unexpanded microspheres (microballoons) (Expancel® 920 DU 20).

The mixture thus obtained was then coated out with a knife coater onto an assembly of 12 μm aluminium and 12 μm PET and dried, with the aluminium side of the assembly being coated. After drying at 110° C., at which the microballoons are not yet foamed, a layer thickness of 30 μm is obtained.

Subsequently, the polyurethane side of the blowing agent layer and the PET side of the newly formed assembly were each laminated with the adhesive. The result was a double-sided adhesive laminate with a layer thickness of around 155 μm.

This laminate was again bonded between two PC (polycarbonate) surfaces as described in the push-out test. The push-out force was then measured. The laminate between the two PC plates was then stored in a magnetic field at 30 kHz for 10 s. The specimen was subsequently removed and the push-out force is measured again. The results are summarized in Table 1.

After the separation of the two substrates, the residues of adhesive that remain were easily removed. The fracture takes place between the PU layer (blowing agent layer) and the aluminium layer. The remnants of the laminate with the aluminium layer were easily removable by peeling, with no residues of adhesive on the PC substrate.

The other side was easily removed by extensive stretching, by stretching the remaining residues of adhesive of the pressure-sensitive adhesive layer, including the polyurethane of the blowing agent layer, starting from one corner. Here again, the remnants could be removed without residue, allowing the PC elements to be used again without cleaning.

### Comparative Example C1

Comparative Example C1 is like Example 1, except the laminate employs an acrylate composition rather than an adhesive based on vinylaromatic block copolymers.

A reactor conventional for radical polymerizations was charged with 47.5 kg of 2-ethylhexyl acrylate, 47.5 kg of n-butyl acrylate, 5 kg of acrylic acid and 66 kg of benzine/acetone (70/30). After nitrogen gas was passed through the reactor for 45 minutes, with stirring, the reactor was heated to 58° C. and 50 g of AIBN was added. Then, the external heating bath was heated to 75° C. and the reaction was carried out constantly at this external temperature. After 1 h a further 50 g of AIBN was added and after 4 h the mixture was diluted with 20 kg of benzine/acetone mixture. After 5.5 and again after 7 h, re-initiation was carried out with in each case 150 g of bis(4-tert-butylcyclohexyl) peroxydicarbonate. After a reaction time of 22 h, the polymerization was discontinued and cooling was conducted to room temperature. The polyacrylate had an average molecular weight of M_{w}=386 000 g/mol, polydispersity PD (M_{w}/Mₙ)=7.6. A 50 μm layer was coated out.

The resulting assembly comprised an adhesive, metal layer (with PET), expandable blowing agent layer and an adhesive was produced again as described in Example 1.

After bonding between the two PC substrates, the push-out force of the assembly was again measured before and after the application of a magnetic field.

After the bond was undone, the residues of adhesive this time were not so easily removed. When one side was peeled, residues of adhesive remained on the substrate. Detachment of the other side by extensive stretching was not possible, since copious residues of material remained here as well.

### Comparative Example C2

Comparative Example C2 is like Example 1, except the laminate did not employ microballoons incorporated into the polyurethane layer.

Here, it was found that the decrease in the push-out force was much lower than in Example 1. If the push-out value is too high, it may be the case that the component will be bent or otherwise damaged during detachment.

### Comparative Example C3

Comparative Example C3 is like Example 1, except the laminate did not employ an aluminium layer. The carrier used was pure PET.

In this case, the tape was not heated and the push-out force was not reduced by the magnetic field.

Table 1 below shows the results of the measured push-out force of the preceding examples and comparative examples.

TABLE 1
Measured push-out force of the examples

| | Push-out after | Push-out after exposure | Removability of |
|---|---|---|---|
| Example | bonding [N] | to magnetic field [N] | adhesive tape remnants |
| 1 | 74.4 | 18.3 | No residues |
| 2 | 63.8 | 15.0 | No residues |
| 3 | 70.9 | 20.5 | No residues |
| C1 | 62.6 | 19.1 | Severe residues |
| C2 | 72.8 | 55.0 | No residues |
| C3 | 76.8 | 75.9 | No residues |

From a review of the data in Table 1 for Examples 1 to 3 it is evident that a high bond strength can be achieved, apparent from the high values in the push-out test after bonding. Exposure to the magnetic field (induction) and the expansion of the blowing agent layer allow the bond strength to be significantly lowered. Here, a force of less than 30 N is advantageous for preventing deformation of the components during separation. In all three Examples 1 to 3, the laminate remnants were easily removable without residue by peeling and extensive stretching respectively.

In contrast, Comparative Example C1 shows that the use of a different adhesive, in this case an acrylate composition, may lead to residue-free removal of the adhesive tape remnants being impossible in spite of easy parting or separation of the bond.

Comparative Example C2 shows that the blowing agent layer is necessary for a significant reduction in the bond strength. While there is a slight decrease in the push-out force, because the adhesives are heated and thereby softened, the push-out force is nevertheless significantly higher than 30 N, with the risk of the substrates or components which were bonded being damaged.

Comparative Example C3 shows that without a metal layer, the application of a magnetic field (induction) had no effect and the bond strength cannot be reduced by the magnetic field.

### LIST OF REFERENCE SIGNS

10 first substrate
11 first pressure-sensitive adhesive layer
12 metal layer
13 blowing agent layer
14 second pressure-sensitive adhesive layer
15 second substrate
40 step of providing an arrangement
50a step of exposing the arrangement (inductive heating in magnetic field)
50b step of exposing the arrangement (heating)
60 step of separating the laminate
70a step of detaching the laminate from a substrate
70b step of detaching the laminate from a substrate
100 laminate
200 arrangement
300 method for detaching a laminate

We claim:

1. A laminate, comprising:
(i) a first pressure-sensitive adhesive layer, the first layer comprising a block copolymer containing at least one polymer block formed from vinylaromatics and at least one polymer block formed from alkenes;
(ii) a metal layer disposed on the first layer;
(iii) a blowing agent layer disposed on the metal layer; and
(iv) a second pressure-sensitive adhesive layer disposed on the blowing agent layer, the second layer comprising a block copolymer containing at least one polymer block formed from vinylaromatics and at least one polymer block formed from alkenes.

2. The laminate according to claim 1, wherein the (i) first pressure-sensitive adhesive layer and/or the (iv) second pressure-sensitive adhesive layer comprises an elastomer component (a), a tackifier resin component (b) and optionally a plasticizing resin component (c).

3. The laminate according to claim 2, wherein the elastomer component (a) comprises a block copolymer having an A-B-A, (A-B)ₙ, (A-B)ₙX or (A-B-A)ₙX construction in which:
the blocks A independently of one another comprise a polymer derived from a polymerization mixture containing vinylaromatic monomers having 8 to 12 carbon atoms;
the blocks B independently of one another comprise a polymer derived from a polymerization mixture containing alkene monomers having 4 to 18 carbon atoms;
X comprises a radical of a coupling reagent or initiator; and
n≥2.

4. The laminate according to claim 3, wherein the blocks A are derived from a polymerization mixture containing styrene and α-methylstyrene.

5. The laminate according to claim 4, wherein the blocks B are derived from a polymerization mixture containing monomers of 1,3-dienes and isobutylene.

6. The laminate according to claim 4, wherein the blocks B are derived from a polymerization mixture containing butadiene and/or isoprene.

7. The laminate according to claim 5, wherein the blocks A have a fraction in the block copolymer in a range from 14 to 35 wt %, and wherein the blocks B have a fraction in the block copolymer in a range from 65 to 86 wt %.

8. The laminate according to claim 5, wherein the (i) first pressure-sensitive adhesive layer and/or the (iv) second pressure-sensitive adhesive layer has a thickness in a range from 25 μm to 3000 μm.

9. The laminate according to claim 5, wherein the (i) first pressure-sensitive adhesive layer and/or the (iv) second pressure-sensitive adhesive layer has a thickness in a range from 50 μm to 1000 μm.

10. The laminate according to claim 8, wherein the (i) first pressure-sensitive adhesive layer and/or the (iv) second pressure-sensitive adhesive layer is a pressure-sensitive adhesive layer characterized by a substantial decrease in tack when substantially stretched in a bond plane direction.

11. The laminate according to claim 10, wherein the (ii) metal layer comprises one or more materials selected from the group consisting of aluminium, copper, nickel, iron, and steel.

12. The laminate according to claim 11, wherein the (iii) blowing agent layer comprises expandable, thermoplastic microspheres.

13. The laminate according to claim 12, wherein the (iii) blowing agent layer comprises at least 50 wt % of a thermoplastic polyurethane.

14. An arrangement, comprising:
a laminate that comprises:
(i) a first pressure-sensitive adhesive layer, the first layer comprising a block copolymer containing at least one polymer block formed from vinylaromatics and at least one polymer block formed from alkenes;
(ii) a metal layer disposed on the first layer;
(iii) a blowing agent layer disposed on the metal layer; and
(iv) a second pressure-sensitive adhesive layer disposed on the blowing agent layer, the second layer comprising a block copolymer containing at least one polymer block formed from vinylaromatics and at least one polymer block formed from alkenes;
a first substrate; and
a second substrate,
wherein the laminate is disposed between the first and second substrates.

15. The arrangement according to claim 14, wherein the (i) first pressure-sensitive adhesive layer and/or the (iv) second pressure-sensitive adhesive layer comprises an elastomer component (a), a tackifier resin component (b) and optionally a plasticizing resin component (c).

16. The arrangement according to claim 15, wherein the elastomer component (a) comprises a block copolymer having an A-B-A, (A-B)ₙ, (A-B)ₙX or (A-B-A)ₙX construction in which:
the blocks A independently of one another comprise a polymer derived from a polymerization mixture containing vinylaromatic monomers having 8 to 12 carbon atoms;
the blocks B independently of one another comprise a polymer derived from a polymerization mixture containing alkene monomers having 4 to 18 carbon atoms;
X comprises a radical of a coupling reagent or initiator; and
n≥2.

17. A method for detaching a laminate, comprising:
providing an arrangement, the arrangement comprising: a laminate; a first substrate; and a second substrate, wherein the laminate is disposed between the first and second substrates;
exposing the arrangement to a temperature in a range from 40 to 200° C.; and
separating the laminate,
wherein the laminate comprises: (i) a first pressure-sensitive adhesive layer, the first layer comprising a block copolymer containing at least one polymer block formed from vinylaromatics and at least one polymer block formed from alkenes; (ii) a metal layer disposed on the first layer; (iii) a blowing agent layer disposed on the metal layer; and (iv) a second pressure-sensitive adhesive layer disposed on the blowing agent layer, the second layer comprising a block copolymer containing at least one polymer block formed from vinylaromatics and at least one polymer block formed from alkenes.

18. The method according to claim 17, wherein the separating the laminate comprises detaching the laminate from at least one of the substrates.

19. The method according to claim 18, wherein the exposing the arrangement comprises subjecting the arrangement to inductive heating in an alternating magnetic field having a frequency in a range from 100 Hz to 200 kHz.

20. The method according to claim 19, wherein the exposing the arrangement further comprises subjecting the (ii) metal layer of the laminate to inductive heating to a temperature in a range from 50 to 200° C. by an alternating magnetic field having a frequency in a range from 10 kHz to 30 kHz for a duration in a range from 1 to 20 s.
